(19) United States
(12) Patent Application Publication
(10) Pub. No.: US 2026/0253783 A1
(43) Pub. Date: Aug. 27, 2026

(54) AN INTEGRATED INDUCTOR

(71) Applicant: AALTO UNIVERSITY FOUNDATION SR, Aalto (FI)

(72) Inventors: Prasad JAYATHURATHNAGE, Aalto (FI); Jorma KYYRÄ, Aalto (FI); Yining LIU, Aalto (FI)

(73) Assignee: AALTO UNIVERSITY FOUNDATION SR, AALTO (FI)

(21) Appl. No.: 18/871,100

(22) PCT Filed: Jun. 1, 2023
(86) PCT No.: PCT/FI2023/050311

§ 371 Date: Dec. 2, 2024

(30) Foreign Application Priority Data
Jun. 3, 2022 (FI) 20227080

(51) Int. Cl. H01F 27/28; H01F 1/34; H01F 27/24

(52) U.S. Cl. CPC H01F 27/28; H01F 1/344; H01F 27/24

(57) ABSTRACT

Various example embodiments relate to an integrated inductor (100), an inductor matrix (700), a wireless power transmitter (800) and a multi-transmitter wireless power transmitter, configured to minimize cross-coupling between adjacent inductors. An example embodiment of an integrated inductor (100) may comprise: a main coil (101), configured horizontally above a first ferrite layer (105); a first auxiliary coil (102), comprising at least one winding and configured vertically on a first side (121) of the integrated inductor; a second auxiliary coil (103), comprising at least one winding and configured vertically on a second side (122) of the integrated inductor; a compensation inductor (104), configured horizontally below the first ferrite layer; and a second ferrite layer (106) configured below the compensation inductor.

### TECHNICAL FIELD

Various example embodiments relate to an integrated coil for multi-transmitter wireless power transfer systems. In particular, example embodiments relate to a multi-layer inductor with auxiliary coils.

### BACKGROUND

Wireless power transfer (WPT) systems may be used in the transmission of electrical energy without physical coupling of conductors between the transmitting and receiving end. WPT has become more common in various applications such as consumer electronics, medical implants and electric vehicle charging. Multi-transmitter WPT (Multi-Tx WPT) systems may be considered to the previously mentioned applications, where multiple transmitters energize single or multiple receivers (Rx) to provide efficient power transmission. A wireless transmitter (Tx) may utilize a transmission coil to create an inductive power transfer between the Tx and Rx. In integrated multi-WPT systems, the transmission coils are generally configured in a planar matrix structure and this matrix structure generates cross-coupling effects between the multiple Tx coils.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may utilize an integrated inductor for reducing the cross-coupling of adjacent integrated inductors, mainly utilized, for example, in a wireless power transmitter circuit, a multi-transmitter wireless power transmitter circuit, or a multi-receiver wireless power receiver circuit.

An example embodiment of an integrated inductor comprises: a main coil, configured horizontally above a first ferrite layer; a first auxiliary coil, comprising at least one winding and configured vertically on a first side of the integrated inductor; a second auxiliary coil, comprising at least one winding and configured vertically on a second side of the integrated inductor; a compensation inductor, configured horizontally below the first ferrite layer; and a second ferrite layer configured below the compensation inductor. For example, the first auxiliary coil and the second auxiliary coils may be constructed in a way, that enables reducing cross-coupling between adjacent inductors. When excited with an input voltage, the horizontally constructed auxiliary coils have a current on the upper track, which is opposite to any current running on any track of the main coil that is located at the same side of the auxiliary coil. Furthermore, with one winding, the required space is reduced, however any number of windings may be chosen if the design requires as such.

In an example embodiment of an integrated inductor, alternatively or in addition to the above-described example embodiment, the main coil further comprises a first port and a second port and wherein the first auxiliary inductor is coupled to the first port and the second auxiliary inductor is coupled to the second port.

In an example embodiment of an integrated inductor, alternatively or in addition to the above-described example embodiments, the compensation inductor comprises a bipolar (DD)-type coil. For example, due to the opposite wound coils in a bipolar-type coil, the compensation inductor may be decoupled from the main coil.

In an example embodiment of an integrated inductor, alternatively or in addition to the above-described example embodiments, the first ferrite layer and the second ferrite layer is constructed out of alternatively a soft ferrite material and a hard ferrite material.

In an example embodiment of an integrated inductor, alternatively or in addition to the above-described example embodiments, the first ferrite layer and the second ferrite layer is alternatively made out of following materials: Co, CoFe, MnZn, NiZn, nanocrystalline and iron powder core.

An example embodiment of an integrated inductor, alternatively or in addition to above-described example embodiments, further comprises: the main coil is constructed on a highest metal layer of an integrated circuit manufacturing process; and a portion of the first auxiliary coil and the second auxiliary coil is constructed alternatively on the highest and the second highest metal layer of the integrated circuit manufacturing process. For example, depending on the size and performance requirements, the auxiliary coils may be constructed on the second highest layer, if the auxiliary coils are wanted very close to the main coil, e.g., the top winding track(s) of each auxiliary coil may run below the main coil. Or alternatively if the second highest metal layer does not offer enough conductivity, the upper winding may, for example, be constructed on the same layer as the main coil.

In an example embodiment of an integrated inductor, alternatively or in addition to above-described example embodiments, the main coil is rectangularly shaped.

In an example embodiment of an integrated inductor, alternatively or in addition to above-described example embodiments, the main coil is circularly shaped and the auxiliary coil windings are arc shaped.

In an example embodiment of an integrated inductor, alternatively or in addition to above-described example embodiments, the main coil is a bipolar (DD)-type coil.

In an example embodiment of an integrated inductor, alternatively or in addition to above-described example embodiments, the main coil is configured as a double-DD-type coil, and the auxiliary coils are configured on sides along the vertical axis.

In an example embodiment of an integrated inductor, alternatively or in addition to above-described example embodiments, the main coil is configured as a double-DDQ-type coil.

An example embodiment of an inductor matrix comprises a plurality of inductor positions, each inductor position comprising: an integrated inductor according to any above-described example embodiment, and wherein each integrated inductor of each inductor position is configured so, that the first auxiliary coil and the second auxiliary coil is facing an adjacent inductor position with an integrated inductor side without an auxiliary coil; and the first ferrite layer of the integrated inductor is configured as a single ferrite plate with openings for the first auxiliary coil and the second auxiliary coil. This example embodiment may allow the inductor matrix to be implemented in a small space.

An example embodiment of a multi-transmitter wireless power transmitter circuit comprises a plurality of wireless power transmitter circuits according to the above-described example embodiment.

An example embodiment of a multi-transmitter wireless power transmitter circuit, in addition to the above-described example embodiment, further comprises the inductor matrix of above-described example embodiment and wherein: each first input terminal is coupled to each respective compensation inductor in the inductor matrix; each second connection point is coupled to each respective first auxiliary coil in the inductor matrix; and each second terminal point is coupled to each respective second auxiliary coil in the inductor matrix.

An example embodiment of a wireless power transmitter circuit comprises any previously described example embodiment of an integrated inductor, wherein the integrated inductor is configured as a transmitter coil.

An example embodiment of a wireless power transmitter circuit comprises: a first input terminal; a second input terminal; and the integrated inductor according to any above-described example embodiment, and wherein: the compensation inductor of the integrated inductor is coupled to the first input terminal; a series capacitor, C_{Tx}, is configured between the compensation inductor and the first auxiliary coil; the second auxiliary coil is coupled to the second input terminal; and a shunt capacitor, C_{f}, configured between the compensation inductor and the second input terminal.

An example embodiment of a multi-transmitter power transmitter circuit comprises a plurality of any previously described example embodiment of a wireless power transmitter circuit.

An example embodiment of a multi-transmitter power transmitter circuit comprises any previously described example embodiment of an inductor matrix and wherein each integrated inductor of the inductor matrix is configured as a transmitter coil.

In an example embodiment of a multi-transmitter power transmitter circuit, alternatively or in addition to the above-described example embodiment, each integrated inductor of the inductor matrix comprises a wireless power-transmitter circuit configured underneath the second ferrite layer.

An example embodiment of a multi-receiver wireless power receiver circuit comprises any above-described example embodiment of an inductor matrix, and wherein each integrated inductor of the inductor matrix is configured as a receiver coil.

An example embodiment of a wireless power transceiver circuit comprises any above-described example embodiment of an inductor matrix, and wherein the inductor matrix is configured alternatively as receiver coils and transmitter coils.

In an example embodiment of a wireless power transceiver circuit, alternatively or in-addition to the above-described example embodiment, a portion of the inductor matrix is configured as receiver coils and a portion of the inductor matrix is configured as transmitter coils.

Example embodiments may provide an integrated inductor, an inductor matrix, a wireless power transmitter circuit, or a multi-transmitter wireless power transmitter circuit for reducing cross-coupling between adjacent inductors. Any example embodiment may be combined with one or more other example embodiments. These and other aspects of the present disclosure will be apparent from the example embodiment(s) described below. According to some aspects, there is provided the subject matter of the independent claims. Some further embodiments are defined in the dependent claims.

### DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates the construction portions of an integrated inductor (100) according to an example embodiment.

FIG. 2 illustrates a power transmitter circuit schematic for example as an example to the embodiment of FIG. 8.

FIG. 3 illustrates an integrated inductor (100) according to an example embodiment and how the wiring between the auxiliary coils (102 and 103) and the main coil (101) could be wired.

FIG. 4 illustrates an inductor matrix and coupling coefficients between adjacent coils according to various example embodiments.

FIG. 5 illustrates a side view of an integrated inductor (100) according to an example embodiment.

FIG. 6 illustrates a bottom view an integrated inductor (100) according to an example embodiment.

FIG. 7 illustrates an inductor matrix (700) according to an example embodiment.

FIG. 8 illustrates a wireless power transmitter circuit (800) according to an example embodiment.

FIG. 9 illustrates a top view of an integrated inductor (900) according to an example embodiment.

FIG. 10 illustrates a top view of an integrated inductor (1000) according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present example embodiments and is not intended to represent the only forms in which the present example embodiment may be constructed or utilized.

Wireless power transfer (WPT) is a method of electrical power transmission that requires no physical contact between a transmitter (Tx) device and a receiver device (Rx). Multiple Txs (a Multi-Tx WPT) have been considered for efficient power transfer for many applications such as electric vehicles, mobile robots, drones, kitchen appliances and consumer electronics. A transmitter system comprising a plurality of transmitters may be referred to as multi-Tx system.

One of the key challenges in the multi-Tx WPT systems is the cross-coupling between closely spaced Tx coils, which may give rise to multiple unwanted issues, such as cross power transfer between the Tx coils, compromised resonance conditions, excitation of reactive currents, and affecting soft switching condition of the power converters.

The use of overlapped coils may help to realize small cross coupling in air-core implemented coils, however, this limits the design freedom as the coil positions need to be fixed. Moreover, it is not possible to fully eliminate cross-coupling between WPT coils with ferrite cores by overlapping the adjacent coils. Ferrite cores are generally implemented when high power transmission is required when operating sub-kHz frequencies due to superior inductive properties. When there is a ferrite layer configured under a Tx coil, mutual inductance between adjacent coils in inevitable.

The following description herein sets forth example embodiments of an integrated inductor with a ferrite core that uses auxiliary coils for reducing the cross-coupling between adjacent inductors, when configured in a matrix-like WPT coil structure. In addition, example embodiments of inductor matrices are described, where the inductor may be utilized efficiently in WPT systems. Other example embodiments set forth a WPT transmitter inductor matrix, wherein embodiments of the single integrated inductor may be applied in. Furthermore, additional example embodiments of electronic circuits (specifically integrated) are presented, wherein embodiments of the integrated inductor may be applied in a single-Tx or a multi-Tx WPT system.

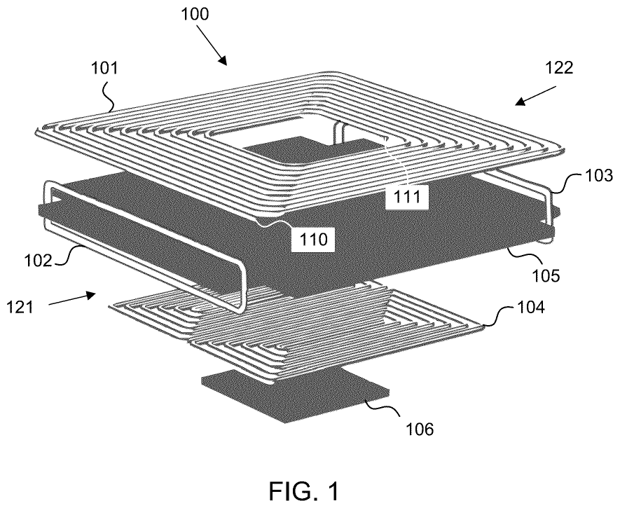

FIG. 1 illustrates an example embodiment of an integrated inductor 100, wherein the integrated inductor 100 comprises a main coil 101, configured horizontally above a first ferrite layer 105. Further, the integrated inductor 100 comprises a first auxiliary coil 102, comprising at least one winding and configured vertically on a first side 121 of the integrated inductor and a second auxiliary coil 103, comprising at least one winding and configured vertically on a second side 122 of the integrated inductor. Furthermore, the integrated inductor 100 comprises a compensation inductor 104, configured horizontally below the first ferrite layer 105 and a second ferrite layer 106 configured below the compensation inductor. The main coil 101 is configured to behave as the WPT coil, while the auxiliary coils 102 and 103 are configured to decouple adjacent inductors in a multi-Tx WPT system. The compensation inductor 104 in this embodiment is configured below the main coil 101 and the first ferrite layer 105 to save space in an integrated design, but it may be configured in other way, depending on the intended use.

The previous description on how the different coils are arranged, e.g., “configured horizontally” and “configured vertically” are used to refer to certain alignment of the coils with respect to each other, and are not meant to restrict the construction of the example embodiment to certain mathematical definition of vertical/horizontal (e.g., x-y axis). For example, the main coil 101 may be configured at a 3-degree angle slope with respect to the first ferrite layer 105, and the auxiliary coils 102 and 103 may be configured at a 95-degree angle with respect to the main coil 101, as long as the overall understanding of general orientation of the coils is maintained, to maintain the desired effect of decoupling as will be described later.

Moreover, the definitions of “first side” 121 and “second side” 122 are given as a means to describe the locations of the auxiliary coils 102 and 103 and the orientation of the integrated inductor 100 in an inductor matrix for a WPT-system. An inductor may, for example, be circularly shaped, thus the concept of having “sides” may be blurred.

Further referring to FIG. 1, in an example embodiment of the integrated inductor 100, the main coil 101 further comprises a first port 110 and a second port 111 and wherein the first auxiliary inductor 102 is coupled in series to the first port and the second auxiliary inductor 103 is coupled in series to the second port. When the integrated inductor 100 is wired this way, any current running on the upper winding track of the auxiliary coils 102, 103, has an opposite direction to any current running on any winding track of the main coil 101 on the same side, coupling the outward magnetic flux from the main coil to the auxiliary coils, creating a desired decoupling effect.

In an example embodiment of the integrated inductor 100, the main coil 101 is circularly shaped, and the at least one winding of the first and second auxiliary coils 102 and 103 is arc-shaped, to track the circular shape of the main coil 101 and maintain constant decoupling effect along the winding tracks of the main coil 101.

As passive electronic components are symmetrical, the order in which the auxiliary coils are wired to the main coil 101 does not change any features of the integrated inductor. And the first port 110 and the second port 111 are presented in order to clarify the example embodiment.

Compensation network topology has an effect on the overall performance of the system. Four first order compensation networks are string-string (SS), string-parallel (SP), parallel-string (PS) and parallel-parallel (PP). In second order compensation networks, an inductor may be added, and these are generally of either LCL or LCC topology.

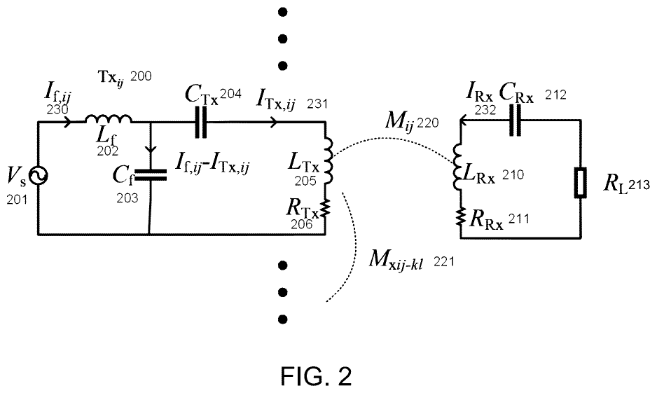

FIG. 2 illustrates a single LCC-series (LCC-S) compensated power transmitter, Txᵢⱼ 200, as lumped circuit components. The denotation ij is the position/numbering of the transmitter in a multi-Tx WPT matrix. An input voltage Vₛ 201 is given, generally by a power inverter, which yields a current I,_{fij} 230 through a compensation inductor, L_{f} 202. In an embodiment, the compensation inductor 104 described above may be configured as the compensation inductor L_{f} 202. A compensation capacitor, C_{f} 203, is configured as a parallel capacitor to resonate with the L_{f} 202. A transmission current I_{Tx,ij} 231 is then passed through a series branch capacitor C_{Tx} 204. The resonant tank in an LCC-S topology is therefore made of L_{f} 202, C_{f} 203 and C_{Tx} 204, which is then sized to resonate with a transmitter inductor L_{Tx} 205. In an embodiment, the L_{Tx} 205 is equivalent to the main coil 101 as illustrated in FIG. 1. A series resistor R_{Tx} 206 may be used to model the internal resistance of the L_{Tx} 205, or to model the series parasitic resistance of the whole Tx side, or to use as a compensation resistor to adjust the resonant frequency. A coupling coefficient Mᵢⱼ 220 between the L_{Tx} 205 and a receiver inductor the L_{Rx} 210 then induces a receiver current I_{Rx} 232 on the receiver Rx, side. A coupling coefficient may be referred to as mutual inductance. The receiver side is configured with a series capacitor C_{Rx} 212 and the load is modelled with a resistor R_{L} 213. As described earlier, in a wireless power transmitter matrix, where multiple inductors are configured closely together, a cross-coupling coefficient Mₓᵢⱼ₋ₖₗ 221 should be added to model the cross-coupling between adjacent transmitters T_{Xi+1,j+1} or T_{Xi-1,j-1} depending on the position of the transmitter in the transmitter matrix. A series resistor R_{Rx} 211 may be used to model the series parasitic resistance of the Rx side.

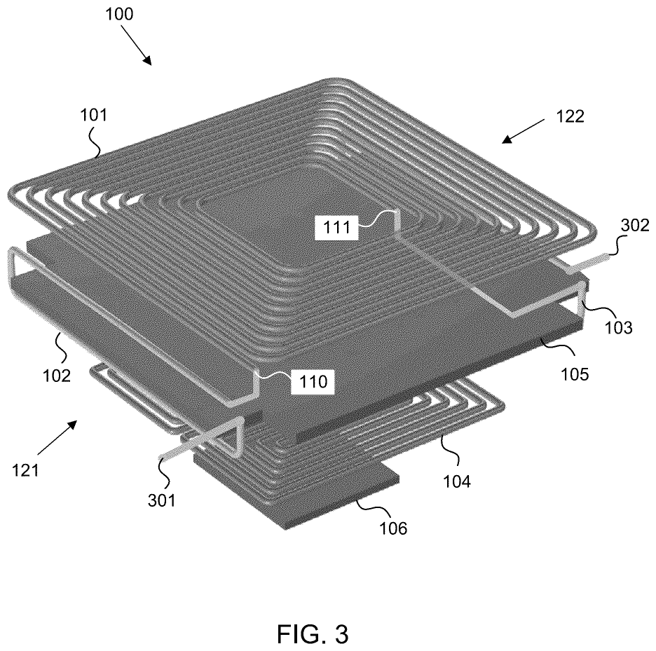

To reduce the cross-coupling between adjacent transmitter inductors L_{Tx} 205 (main coil 101), decoupling inductors should be considered. FIG. 3 illustrates an example embodiment of the integrated inductor 100 and how the first auxiliary coil 102 and the second auxiliary coil 103 may be connected to the main coil 101 to attain the desired decoupling effect. An input port 301 is wired to extend outwards toward the first side 121 of the integrated inductor 100, which couples the first auxiliary coil 102 to the input port 301. Considering an input current to the integrated inductor 100 in the input port 301, the upper winding track of the first auxiliary coil 103 and each winding of the first side 121 of the main coil 100 has a current that are of different direction, creating a desired magnetic coupling between each winding of the main coil 100 and the auxiliary coil 102. On the second side 122 of the integrated inductor 100, the second auxiliary coil 103 behaves similarly, as any current running on the second side 122 of the main coil 101 is of different direction than the upper winding of the second auxiliary coil 103. Furthermore, an output port 302 may then be configured to extend outwards from the integrated inductor 100. The first port 110 of the main coil 101 may be wired as illustrated in FIG. 3—on the first side 121, the upper winding track of the first auxiliary coil 102 may be extended inwards on top of the first ferrite layer 105 and then bring the track upwards to create a connection to the first port 110. An on the second side 122, the second port 111 may be wired to extend downwards towards the first ferrite layer 105 and then run towards the lower winding track of the second auxiliary coil 103.

When referring to “current direction” in the previously described example embodiment, it may be referred to as AC current direction at some time, wherein it is easier to understand the magnetic coupling between the coils due to the induction effect. For example, a reference AC current is injected to the first auxiliary coil 102, therefore this current running on a lower winding track of the first auxiliary coil 102 induces a changing magnetic field on the upper winding track of the first auxiliary coil 102, which induces a current that opposes the change of the induced magnetic field. However, the reference AC current is running on the same time on the upper winding track of the first auxiliary coil 102, therefore the induction current direction is opposite between upper and lower winding tracks, and between the tracks running on the first side 121 of the main coil 101, decoupling the magnetic field of the main coil 101 from any adjacent coils between the main coil 101 and the first auxiliary coil 102.

The cross-coupling between Tx coils causes an unwanted energy exchange between Txs, which affects the performance and operation of the multi-Tx WPT system. These effects of cross coupling can be evaluated by analysing the Tx-side currents illustrated in FIG. 2. An equivalent circuit analysis may be used to derive the system equation as following:

$${V}_{s} = {jw}_{0} {L}_{f} {I}_{f , ij} + \frac{{I}_{f , ij} - {I}_{Tx , ij}}{{jw}_{0} {C}_{f}} \qquad ( 1 )$$

$$0 = ( {jw}_{0} {L}_{Tx} + \frac{1}{{jw}_{0} {C}_{Tx}} + {R}_{Tx} ) {I}_{Tx , ij} - \frac{{I}_{f , ij} - {I}_{Tx , ij}}{{jw}_{0} {C}_{f}} + {jw}_{0} {M}_{ij} {I}_{Rx} + \sum {jw}_{0} {M}_{xij , kl} {I}_{Tx , kl} \qquad ( 2 )$$

$$0 = ( {jw}_{0} {L}_{Rx} + \frac{1}{{jw}_{0} {C}_{Rx}} + {R}_{Rx} + {R}_{L} ) + \sum {jw}_{0} {M}_{ij} {I}_{Tx , ij} , \qquad ( 3 )$$

where w₀ is the working angular frequency, Vₛ is the fundamental component of an inverter output voltage, L_{f} is the inductance of the compensation inductor, C_{f} is the parallel branch capacitance, and C_{Tx} is the series branch capacitance in the LCC-network. Mᵢⱼ is the mutual inductance between Rx and I_{Tx,ij} e.g., the Tx coil at row i and column j. M_{xij,kl} represents the cross-coupling mutual inductance between Tx e.g., Txᵢⱼ and Txₖₗ, where k,l∉i, j.

Considering the ideal lossless case, the current through the compensation inductor I_{f,ij} is affected by the mutual inductances between Txs as

$${I}_{f , ij} = \frac{{M}_{sum} {M}_{ij}}{{L}_{f}^{2}} \frac{{V}_{s}}{{R}_{L}} + j \frac{{V}_{s}}{{w}_{0} {L}_{f}^{2}} \sum {M}_{xij , kl} , \qquad ( 4 ) )$$

where Mₛᵤₘ is the sum of mutual inductances between all Tx coils and the Rx, which may be defined as Mₛᵤₘ=Σ_{∉∀i,i}|Mᵢⱼ|. The sum of all mutual inductances between coil Txᵢⱼ and all other active Txs is given by ΣM_{xij,kl}. In Eq. 4, there is an introduction of reactive component to I_{f,ij} due to cross-coupling between Txs. In case of an active Tx coil, this reactive current introduces a capacitive input impedance to the component driving the Tx, i.e., a full-bridge converter, which may, for example, affect the soft switching condition and increase losses in an inverter. Similarly, the currents flowing through compensation inductors in inactive coils are also increased due to the effect of cross-coupling, which leads to higher losses in the affected compensation inductor.

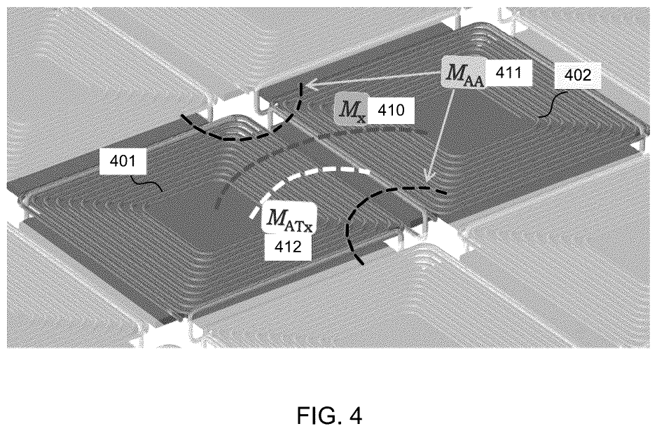

To further examine the effect of the auxiliary coils 102 and 103, FIG. 4 illustrates two adjacent inductors 100 at 401 and 402, configured horizontally in a WPT matrix, so that each auxiliary coil of each integrated inductor 100 is facing a side of an adjacent inductor with no auxiliary coil. Considering any pair of two neighbouring blocks, the following coupling effects are dominating: At first, a cross-coupling between the main coils 101, Mₓ 410. Secondly, coupling between two auxiliary coils of one block and an adjacent block M_{AA} 411. And thirdly, the coupling between one auxiliary coil of one of the inductors 100 and the main coil 101 of the second inductor M_{ATx} 412. The latter two, M_{AA} 411 and M_{ATx} 412, have opposite sign compared to the first coupling Mₓ 410. The total mutual inductance M′ₓ between two adjacent inductors is presented in Equation 5.

$${M}_{x}^{′} = {M}_{x} - {M}_{AA} - {M}_{ATx} . \qquad ( 5 )$$

In order to nullify the total cross coupling M′ₓ, the amount of turns and the cross-section area of the auxiliary coils may be chosen accordingly to ensure that M′ₓ is minimized.

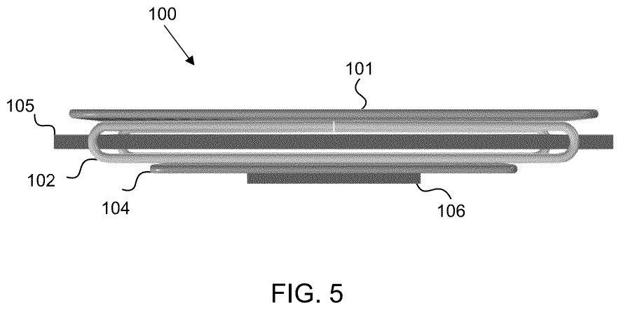

FIG. 5 illustrates a side view of the first side 121 of an example embodiment of the integrated inductor 100. The first auxiliary coil 102 has one winding, configured on a metal layer below the main coil 101 and the backplate inductor 104 is configured below the first ferrite layer 105.

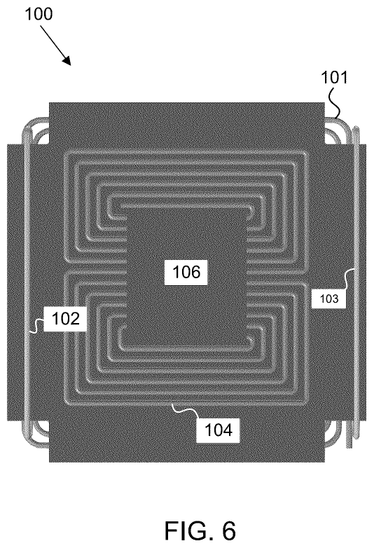

Further, FIG. 6 illustrates a bottom view of an example embodiment of the integrated inductor 100, where the compensation inductor 104 is configured in a bipolar (DD) type inductor topology. The first ferrite layer 105 and the second ferrite layer 106 are configured on both sides of the compensation inductor so that the bipolar flux generated by the DD-type coil is confined to the Tx coil structure with low leakage flux. Due to the oppositely wound coils in the DD-type coil, the compensation inductor is naturally decoupled from the main coil 101 and the auxiliary coils 102 and 103. The desired value of the compensation inductor may be achieved by optimizing the width, length, number of turns and the size of the second ferrite layer 106.

In an example embodiment of the integrated inductor 100, the first auxiliary coil 102 and the second auxiliary coil 103 have a plurality of windings. Multiple windings may be implemented if the requirements to minimize the total cross coupling M′ₓ is not achieved with a single winding.

Therefore, coils of the proposed design may be used as modular, fully integrated coils for multi-Tx WPT systems. Additionally, the proposed methods and configurations for decoupling of multiple coils and integration of the compensation inductor may be used independently, depending on the application requirements. For example, decoupling auxiliary coils may be used with series compensated main coil 101 without compensation inductor 104 or vice-versa without decoupling coils, the compensation inductor 104 may be used without the decoupling auxiliary coils. Finally, the proposed embodiment, where the compensation inductor 104 is configured below the main coil 101 (and between the ferrite layers) saves space in an integrated circuit.

The integrated inductor 100 may be constructed, for example, with modern integrated circuit manufacturing processes. For example, the main coil 101 may be constructed of a typical, highly conductive, high top metal layer. The first auxiliary coil 102 and the second auxiliary coil 103 may be constructed of a single low top metal layer if available, or un-ideally if a single multi-layer top metal is not available, the auxiliary coils 102 and 103 may be constructed of multiple metal layers connected with vias connecting the layers horizontally. The ferrite layers 105 and 106 may be constructed of any chosen (and/or available) ferrite material such as Co-based, CoFe-based, MnZn-based or NiZn-based, to name a few. In an example embodiment of the integrated inductor 100, the first ferrite layer 105 and the second ferrite layer 106 is made out of alternatively a soft ferrite material and a hard ferrite material. The compensation inductor 104 may then be constructed with the appropriate metal layer in the manufacturing process, depending on the thickness of the ferrite layer.

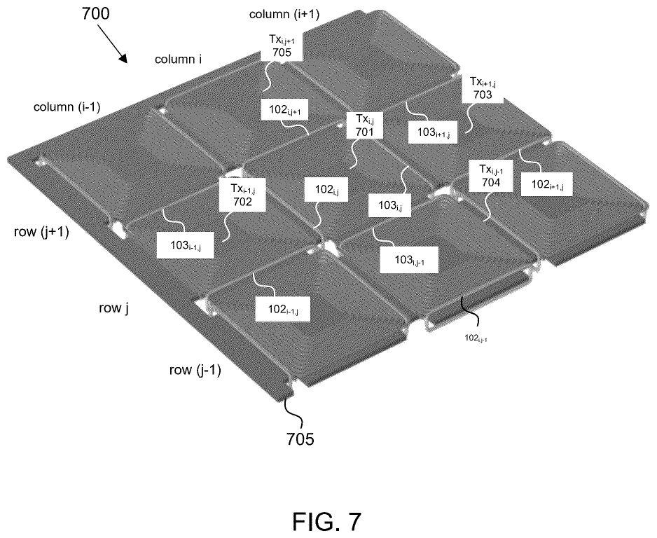

FIG. 7 illustrates an example embodiment of an inductor matrix 700, wherein the inductor matrix 700 comprises a plurality of integrated inductors 100 according to any preceding claim, and wherein each integrated inductor is configured: that the first side 121 is facing an adjacent inductor position with an integrated inductor side without an auxiliary coil; that the second side 122 is facing an adjacent inductor position with an integrated inductor side without an auxiliary coil; and that the first ferrite layer 105 of the plurality of integrated inductors is configured as a single ferrite plate 705 comprising openings for the first auxiliary coils and the second auxiliary coils.

In FIG. 7, the integrated inductor 100 positions (locations) in the inductor matrix 700 may be denotated by i for column numbering and j for row numbering and all integrated inductors 100 are illustrated as a Tx-coils Txᵢⱼ corresponding the position denotation. Further in FIG. 7, an integrated inductor 100 is illustrated as Txᵢⱼ 701 at the matrix center position i,j. The inductors are configured so that the adjacent inductors T_{Xi+1,j} 703, T_{Xi-1,j} 702, Txᵢⱼ₊₁ 705, T_{Xi,j-1} 704 each have a side that does not face the first auxiliary coil 102ᵢⱼ or the second auxiliary coil 103ᵢⱼ of the middle inductor Txᵢⱼ 701. In other words, each row position j−1, j, j+1 has a 90-degree rotation of the integrated inductor 100 between each other and each column position i−1, i, i+1 has a 90-degree rotation of the integrated inductor 100 between each other. The first ferrite layer 105 is configured as a single ferrite plate 705, comprising appropriate openings for the auxiliary coils. This arrangement ensures proper decoupling between the adjacent integrated inductors 100.

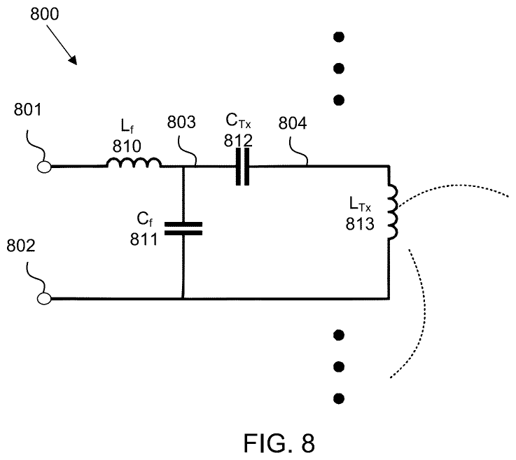

FIG. 8 illustrates a schematic of an example embodiment of a wireless power transmitter circuit 800, wherein an embodiment of the integrated inductor 100 may be applied in. The wireless power transmitter circuit 800 comprises: a first input terminal 801 and a second input terminal 802. The compensation inductor 104 of the integrated inductor 100 may be coupled to the first input terminal 801, and is illustrated as a compensation network component L_{f} 810 in FIG. 8, coupled between connection points 803 and the first input terminal 801. A series capacitor, C_{Tx} 812 is then configured between the compensation inductor 104 and the first auxiliary coil 102 of the integrated inductor 100 (between connection points 803 and 804), e.g., an input to the first auxiliary coil 102 is illustrated as the connection point 804 in FIG. 8. Furthermore, the second auxiliary coil 103 is coupled to the second input terminal 802, therefore the main coils and the auxiliary coil 102, 103 act as the transmission coil L_{Tx} 813 in FIG. 8. Finally, the wireless power transmitter 800 comprises a shunt capacitor, C_{f} 811, configured between the compensation inductor and the second input terminal.

Furthermore, FIG. 8 illustrates the coupling coefficients Mᵢⱼ between a receiver coil L_{Rx} 812 and Mₓᵢⱼ₋ₖₗ between the adjacent transmitter coils, as the wireless power transmitter 800 may be configured in a multi-Tx WPT system.

This example embodiment is wired as such, to create a clarification in the embodiment itself. The direction in which the integrated inductor is connected to the wireless power transmitter does not change any features in the wireless power transmitter itself and mostly depends on the final design engineer who draws the layout for the transmitter. In addition, this is an example of a simple WPT-Tx topology, as the integrated inductor 100 may be applied as such in any WPT-Tx topology.

The example embodiment of FIG. 8 does not limit the scope of WPT topologies, wherein the integrated inductor 100 may be used, as the integrated inductor 100 and the inductor matrix 700 may be utilized in any WPT topology with or without a compensation capacitor requirement, as the compensation capacitor may be left unconnected in some embodiments.

Any WPT circuit utilizing an embodiment of the integrated inductor 100 as a Tx-coil may be constructed, for example, underneath the integrated inductor 100. As multi-layer integrated circuit manufacturing processes generally may have the top layers reserved for inductors, transmission lines and larger capacitors, therefore any transistor device, such as a field-effect transistor (FET) or a bipolar-type transistor (BJT) device, may be constructed on top of the lowest substrate level. This type of arrangement may save space in tightly fitted multi-WPT systems.

An example embodiment of a multi-transmitter wireless power transmitter circuit comprises a plurality of the above-described embodiment of the wireless power transmitter circuit 800. E.g., a power inverter matrix may be configured to drive each input terminals 801 and 802 of an inductor network.

An example embodiment of a multi-Tx WPT system comprises the above-described example embodiment of the inductor matrix 700.

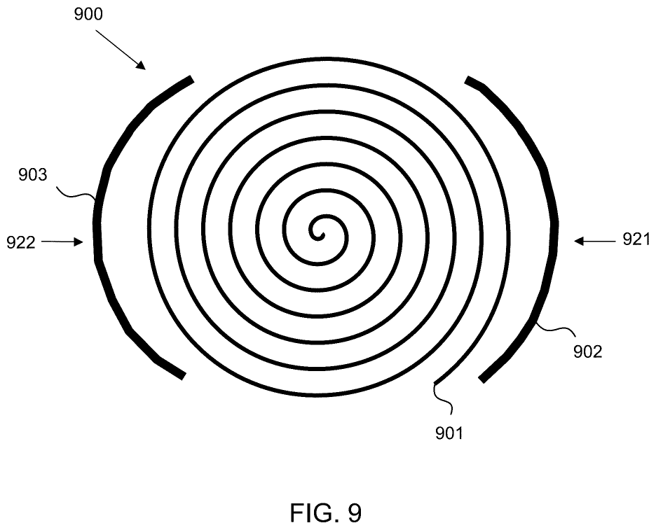

The integrated inductor (100) has been previously illustrated as having a rectangular shape as shown in FIGS. 1 and 3-8. However, the integrated inductor may be configured as any inductor shape best suited for the chosen task. FIG. 9 illustrates a top view of a circular shaped integrated inductor 900, wherein the main coil 901 is configured circularly and auxiliary coils 902 and 903 are configured arc-shaped to track the outer spiral of the main coil 901, which creates a uniform decoupling effect along the auxiliary coil 902 and 903 and thus the integrated inductor 900 may be configured in a WPT-Tx matrix system, wherein the adjacent inductors have a 90-degree rotation with respect to each other. The first side 921 and the second side 922 are illustrated as creating a diagonal axis through the middle of the auxiliary coils 902 and 903.

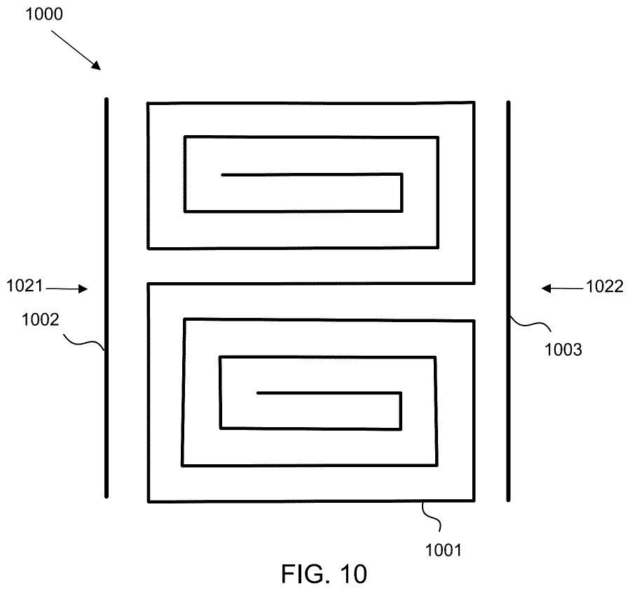

Furthermore, FIG. 10 illustrates an integrated inductor 1000, wherein a main coil 1001 is configured as a DD-type bipolar coil, and auxiliary coils 1002 and 1003 are arranged to decouple the magnetic flux from the sides. A DD-type coil as a main Tx-coil may even further decrease cross-coupling between the Tx-coils in a WPT-Tx matrix. The auxiliary coils 1002 and 1003 are configured along the vertical axis as illustrated in FIG. 10.

Even furthermore, in an example embodiment of the integrated inductor 100, the main coil 101 is configured as a double-DD type coil, wherein two DD-type coils are stacked on top of each other, however the upper and lower DD-coils have a 90 degree angle rotation with respect to each other.

In an example embodiment of the integrated inductor 100, the main coil 101 is configured as a double-DDQ type coil, wherein two DD-type coils and a Q-type coil (normal rectangular shape) are stacked on top of each other. As per the previously described embodiment of the integrated inductor 1000, the DD-coils have a 90-degree rotation with respect to each other and a Q-type coil is stacked on top of the two DD-type coils.

In addition to utilizing the integrated inductor 100 as a Tx-coil, any embodiments of the integrated inductor 100 and the inductor matrix 700 may be utilized alternatively in the receiver (Rx)-side, or even furthermore, as a transceiver-type device, wherein an embodiment of the inductor matrix 700 may be switchable between Tx- and Rx-configurations or a portion of the inductor matrix 700 may be configured simultaneously as Rx and another portion as Tx. Any application requiring decoupling between inductors may utilize embodiments of the integrated inductor 100 and the inductor matrix 700.

Even furthermore and as an example, the inductor matrix 700 comprising the integrated inductor 100, may be for example configured in a wireless WPT-system both in the Tx-side and the Rx-side. For example, a wireless electric vehicle charger may comprise a multi-Tx system comprising the inductor matrix 700, wherein each integrated inductor 100 of the inductor matrix 700 is configured as a Tx-coil, and a wireless receiver on the electric vehicle side comprises the inductor matrix 700, wherein each integrated inductor 100 of the inductor matrix 700 is configured as a receiver coil.

Although the subject matter has been described in language specific to structural features and/or acts, it is to be understood that the subject matter defined in the appended claims is not necessarily limited to the specific features or acts described above. Rather, the specific features and acts described above are disclosed as example embodiments of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

Additionally, individual blocks may be deleted from any of the example embodiments without departing from the scope of the subject matter described herein. Aspects of any of the example embodiments described above may be combined with aspects of any of the other example embodiments described to form further example embodiments without losing the effect sought.

The term ‘comprising’ is used herein to mean including the method, blocks, or elements identified, but that such blocks or elements do not comprise an exclusive list and a method or apparatus may contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

The term ‘circuit’ used herein may comprise an integrated circuit, or alternatively it may comprise an electric circuit constructed of individual circuit elements that may be purchased separately and constructed for example, on a circuit board.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An integrated inductor, comprising:
a main coil configured horizontally above a first ferrite layer;
a first auxiliary coil comprising at least one winding and configured vertically on a first side of the integrated inductor;
a second auxiliary coil comprising at least one winding and configured vertically on a second side of the integrated inductor;
a compensation inductor configured horizontally below the first ferrite layer; and
a second ferrite layer configured below the compensation inductor.

2. An integrated inductor according to claim 1, wherein:
the main coil further comprises a first port and a second port and wherein the first auxiliary inductor is coupled in series to the first port and the second auxiliary inductor is coupled in series to the second port.

3. An integrated inductor according to claim 1, wherein the compensation inductor comprises a bipolar (DD)-type coil.

4. An integrated inductor according to claim 1, wherein the first ferrite layer and the second ferrite layer are made out of alternatively a soft ferrite material and a hard ferrite material.

5. An integrated inductor according to claim 1, wherein the first ferrite layer and the second ferrite layer are Co-based, CoFe-based, MnZn-based, NiZn-based, nanocrystalline-based and iron powder-based.

6. An integrated inductor according to claim 1, wherein:
the main coil is constructed on a highest metal layer of an integrated circuit manufacturing process; and
a portion of the first auxiliary coil and the second auxiliary coil are constructed alternatively on the highest and the second highest metal layer of the integrated circuit manufacturing process.

7. An integrated inductor according to claim 1, wherein the main coil is rectangularly shaped.

8. An integrated inductor according to claim 1, wherein the main coil is circularly shaped and the windings of the first and second auxiliary coil are arc shaped.

9. An integrated inductor according to claim 1, wherein the main coil is a bipolar (DD)-type coil.

10. An integrated inductor according to claim 1, wherein the main coil is configured as a double-DD-type coil, and the auxiliary coils are configured on sides along the vertical axis.

11. An integrated inductor according to claim 1, wherein the main coil is configured as a double-DDQ-type coil.

12. The integrated inductor of claim 1, within an inductor matrix of a plurality of such integrated inductors, wherein each integrated inductor in the matrix is configured:
that the first side is facing an adjacent inductor position with an integrated inductor side without an auxiliary coil;
that the second side is facing an adjacent inductor position with an integrated inductor side without an auxiliary coil; and
that the first ferrite layer of the plurality of integrated inductors is configured as a single ferrite plate comprising openings for the first auxiliary coils and the second auxiliary coils.

13. The integrated inductor of claim 12, wherein each integrated inductor of the inductor matrix is configured as a transmitter coil.

14. The integrated inductor of claim 13, wherein each integrated inductor of the inductor matrix comprises a wireless power-transmitter circuit configured underneath the second ferrite layer.

15. The integrated inductor of claim 12, wherein each integrated inductor of the inductor matrix is configured as a receiver coil.

16. The integrated inductor of claim 12, wherein the inductor matrix is configured alternatively as receiver coils and transmitter coils.

17. The integrated inductor of claim 12, wherein a portion of the inductor matrix is configured as receiver-coils and a portion of the inductor matrix is configured as transmitter coils.

18. The integrated inductor of claim 1, within a wireless power transmitter circuit and wherein the integrated inductor is configured as a transmitter coil.

19. The integrated inductor of claim 1, within a wireless power transmitter circuit comprising:
a first input terminal;
a second input terminal; and wherein the compensation inductor is coupled to the first input terminal;
a series capacitor is configured between the compensation inductor and the first auxiliary coil;
the second auxiliary coil is coupled to the second input terminal; and
a shunt capacitor is configured between the compensation inductor and the second input terminal.

20. The integrated inductor of claim 1 within a multi-receiver, wherein the integrated inductor is configured as a receiver coil.
